(19) United States
(12) Patent Application Publication
(10) Pub. No.: US 2007/0075138 A1
(43) Pub. Date: Apr. 5, 2007

(54) System for encoding and/or deconding data

(76) Inventor: William Ross, London (GB)

Correspondence Address: FLYNN THIEL BOUTELL & TANIS, P.C., 2026 RAMBLING ROAD, KALAMAZOO, MI, 49008-1631, US

(21) Appl. No.: 10/553,528

(22) PCT Filed: Apr. 14, 2004
(86) PCT No.: PCT/GB04/01622

§ 371 Date: Aug. 18, 2006

(30) Foreign Application Priority Data
Apr. 14, 2003 (GB) 0308594.1

(51) Int. Cl. G06K 7/00

(52) U.S. Cl. 235/435

(57) ABSTRACT

A memory device comprising an array of bits or binary units (2), the bits (2) being defined by a plurality of first conductors (4) and either a second conductor or a plurality of second conductors (5) overlying and separated from the first conductors, each bit (2) including a cross-over point (9) between one of the first conductors (4) and the second conductor (5), or one of the second conductors (5), and wherein a selection of the bits (2) also include a signal bridge connecting the first (4) and second (5) conductors at each of the respective selected pixels.

The present invention is concerned with systems, apparatus and/or methods for encoding and/or decoding data. In particular, the invention is concerned with the encoding of data into a binary format and the decoding of data from a binary format. Preferred embodiments of the present invention are particularly suitable for encoding identification or verification information, or, suitable for the authorised user of a data carrier such as a passport, credit or payment card.

It is well known to encode data on data carriers in a code format. This may be as a binary code or as bar codes. Bar codes are a commonly used form of encoding or recording data. A bar code symbol is an optical pattern comprised of a series of bars of various widths and spaced apart from one another by spaces of different width, the bars and spaces having different light reflective properties. The bars represent strings of binary ones and the spaces represent strings of binary zeros.

Bar code symbols are typically printed directly on an object or on labels that are attached to an object. The bar code symbols are read by optical techniques such as scanning laser beams or CCD cameras.

Another known method for encoding data on data carriers in a binary code are so-called magnetic stripes. Magnetic stripes rely upon the HALL Effect for their efficacy. Discrete magnetic poles are written into a thin film of ink which contains iron oxide which makes it easily magnetisable. A wire loop is held close to the surface of the printed film and a current passed through it. This magnetises the iron based film and a ‘pole’ is set up locally. To write data onto the card a series of poles are set up in accordance with the standard in much the same way as bar codes by laying down closely aligned poles, the number and spaces being written according to the code for the data being written. The data is read back by using a driven loop to sense the presence of a pole, the ‘read’ head being similar to the ‘write’ head.

Bar codes and magnetic stripes suffer from a number of possible disadvantages which make them inappropriate for certain uses and environments. These include:
a) Bar code and magnetic stripes can be easily read by unauthorised people. They are not therefore suitable for confidential information.
b) Bar codes and magnetic stripes require a lot of space and are not therefore useful for storing anything other than very small amounts of information.

The present invention provides a memory device, a card and/or a method as defined in independent claims 1, 10 and 17 to which reference should now be made. Preferred features of the invention in its various aspects are set out in the dependent claims to which reference should now be made.

There are a number of occasions when it can be important to verify someone's identity and/or that their identification or other documentation they are trying to use is in fact their own. Credit and/or payment card fraud is a big problem for banks and other card issuers who lose very large sums. The unauthorised use of stolen travel documents by criminals and/or terrorists can also have tragic consequences for safety, law and order. The ability to check and confirm identities is therefore clearly valuable as is the ability to easily and cheaply make security aids which are difficult to bypass or forge. The security device of the present invention could be used for remote identification in a system such as that described in WO 97/25691.

Preferred embodiments of the present invention will now be described, by way of example only, with reference to the attached figures, in which:

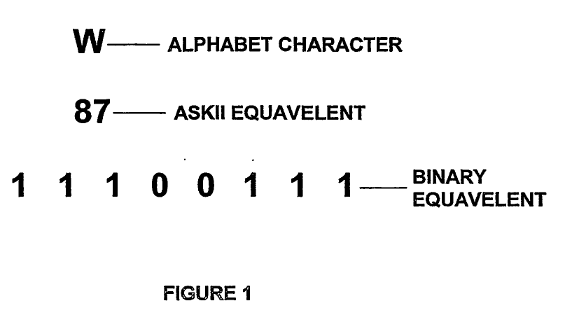

FIG. 1 illustrates how binary codes can be used to represent alphanumeric characters;

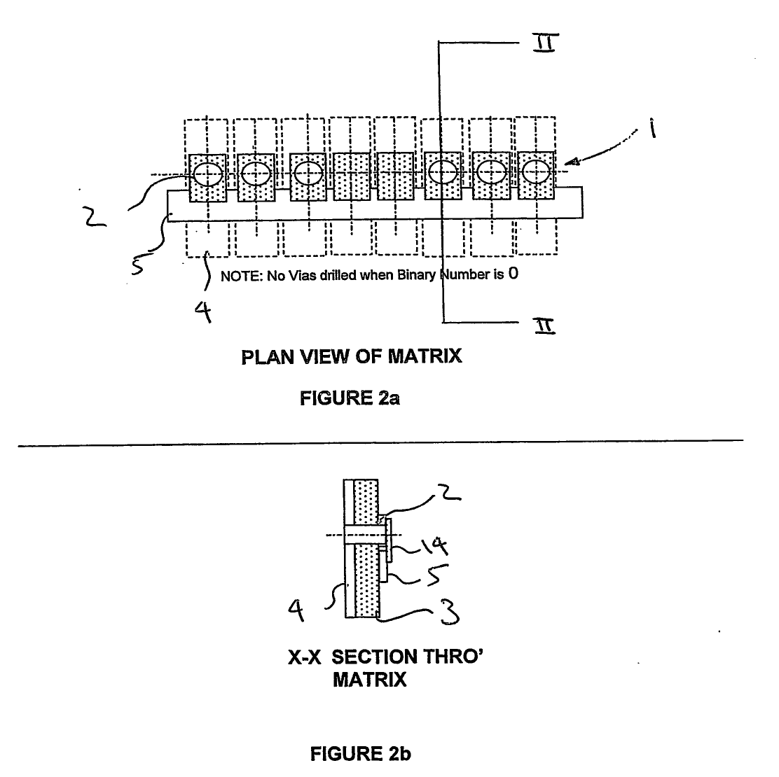

FIG. 2a is a schematic plan view illustrating the binary code representations used in embodiments of the invention;

FIG. 2b is a view along section II-II of FIG. 2a;

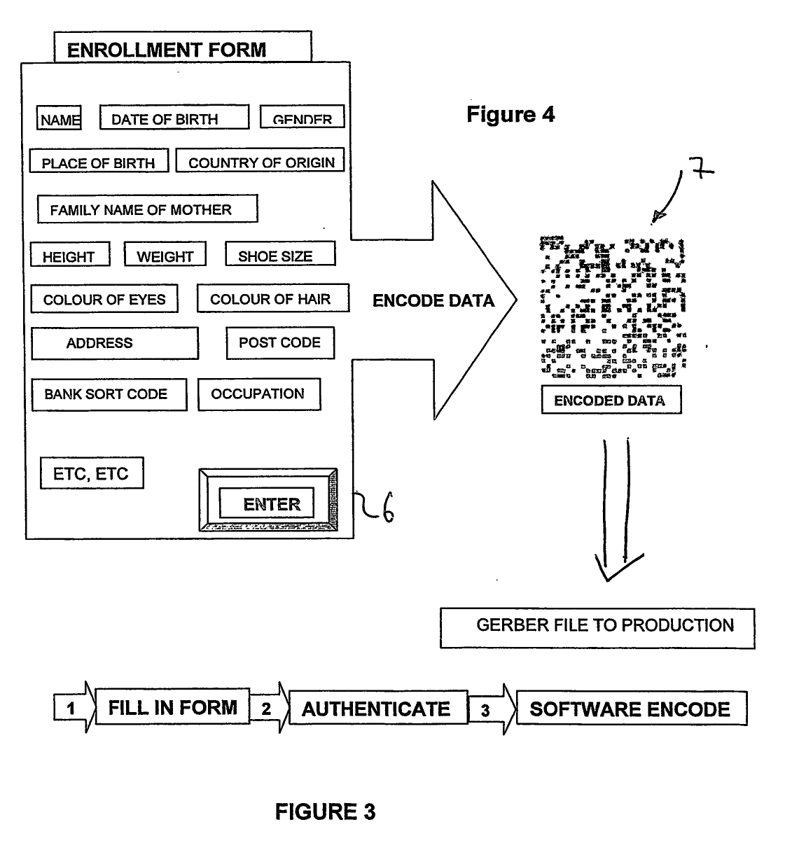

FIGS. 3 and 4 illustrate a method for setting up a card such as a payment or credit card to include encoded or stored information;

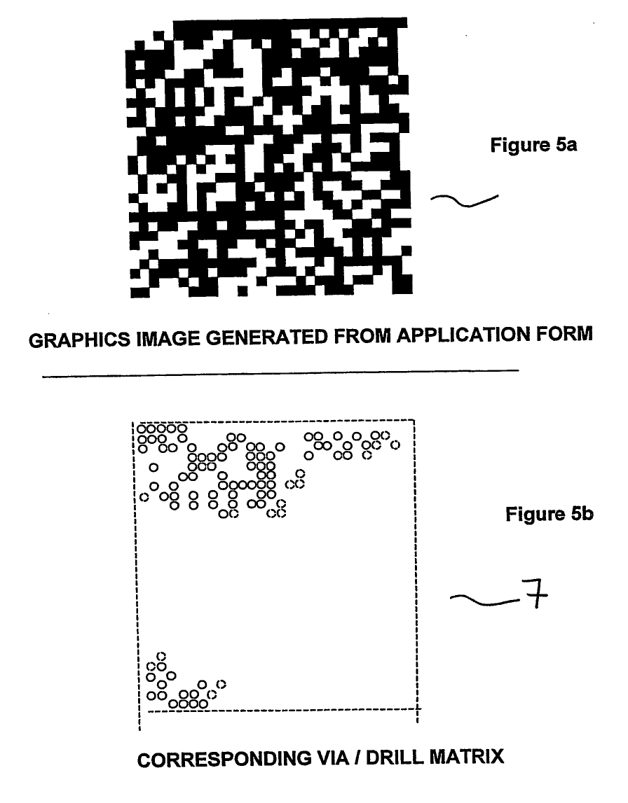

FIGS. 5a and 5b illustrate, respectively, the graphics image produced by the method of FIGS. 3 and 4 and part of the corresponding via/drill array representing that image;

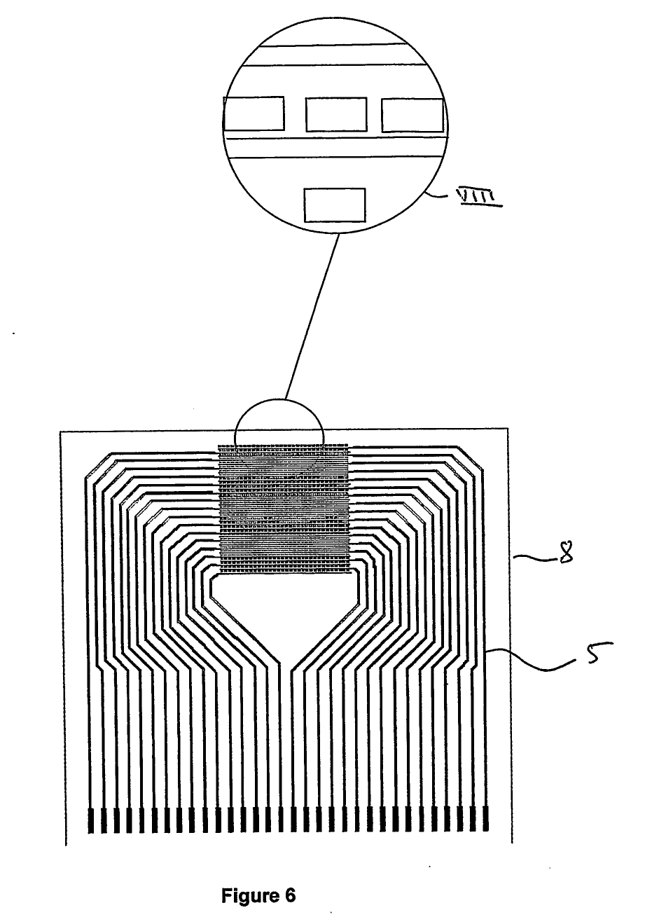

FIG. 6 illustrates the upper surface of a data carrier embodying the invention;

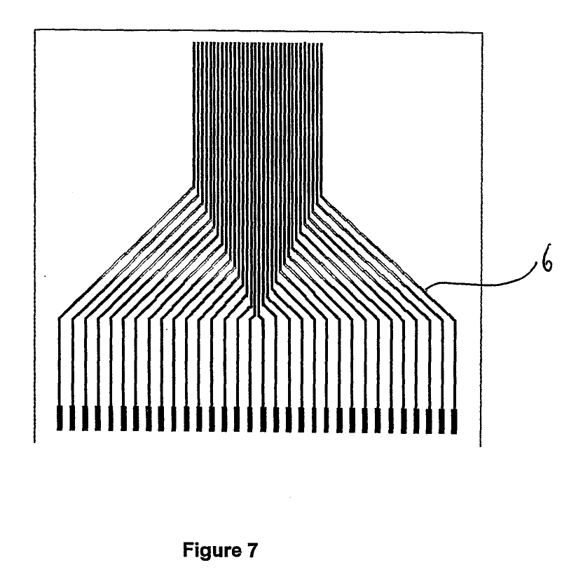

FIG. 7 illustrates the lower surface of the data carrier of FIG. 6;

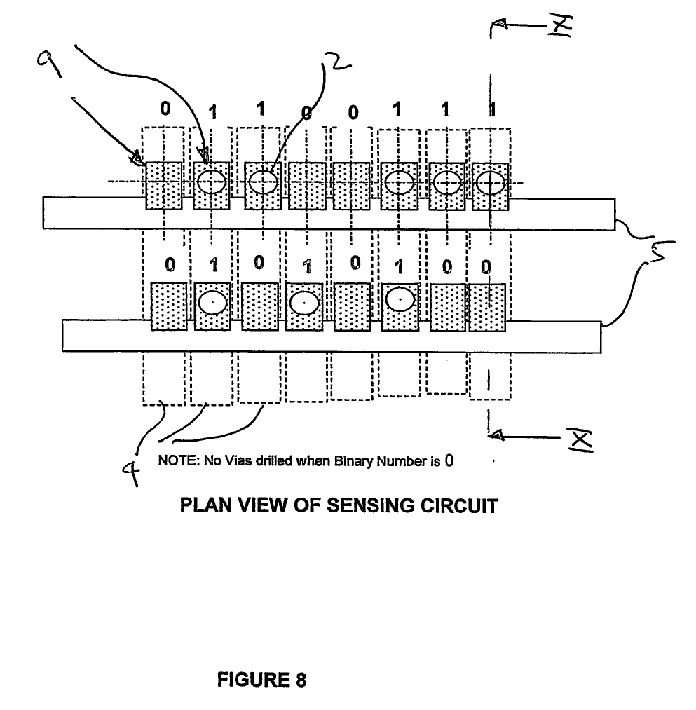

FIG. 8 is a schematic plan view of the details of FIG. 6 marked VIII;

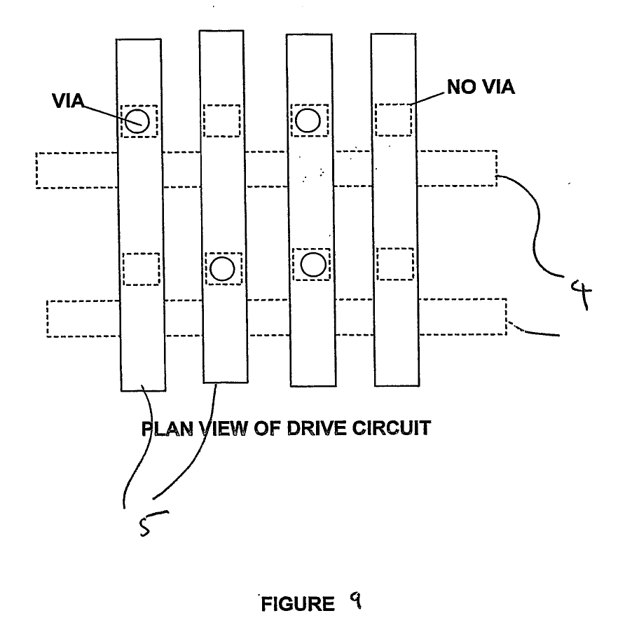

FIG. 9 is a schematic view of the details of the portion of FIG. 7 marked IX;

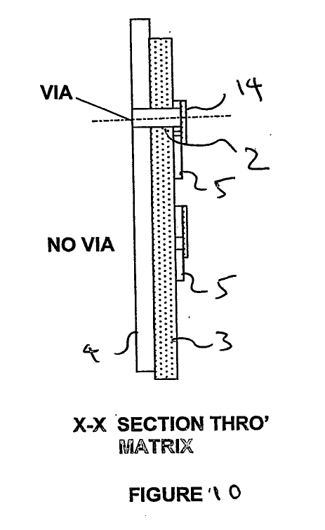

FIG. 10 is sectional view along sections X of FIGS. 8 and 9;

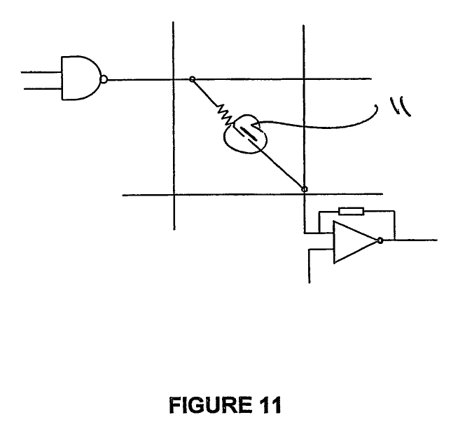

FIG. 11 is a schematic plan view illustrating a circuit diagram representation of a via of FIGS. 8 to 10;

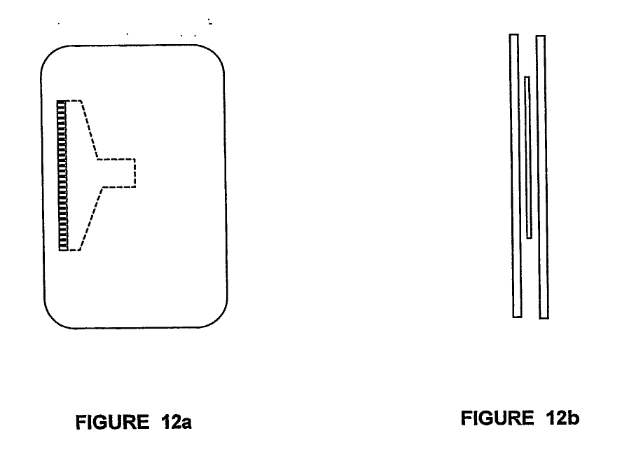

FIG. 12a and 12b show, respectively, plan and expanded sectional views of a transaction or identity card including a data carrier embodying the invention;

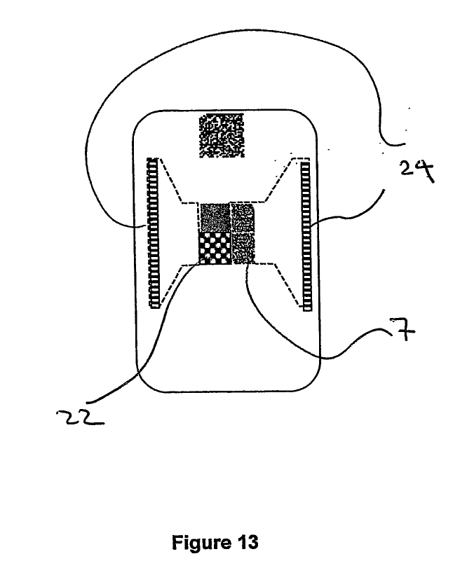

FIG. 13 shows an alternative transaction or identity card embodying the invention;

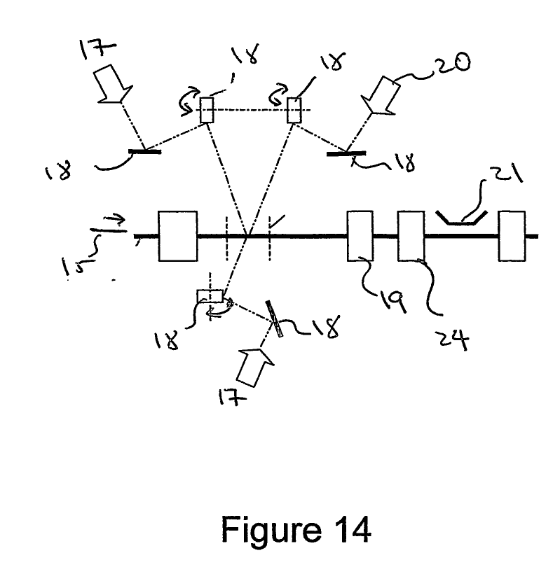

FIG. 14 illustrates apparatus and method for manufacturing the data carrier of FIGS. 2 to 13;

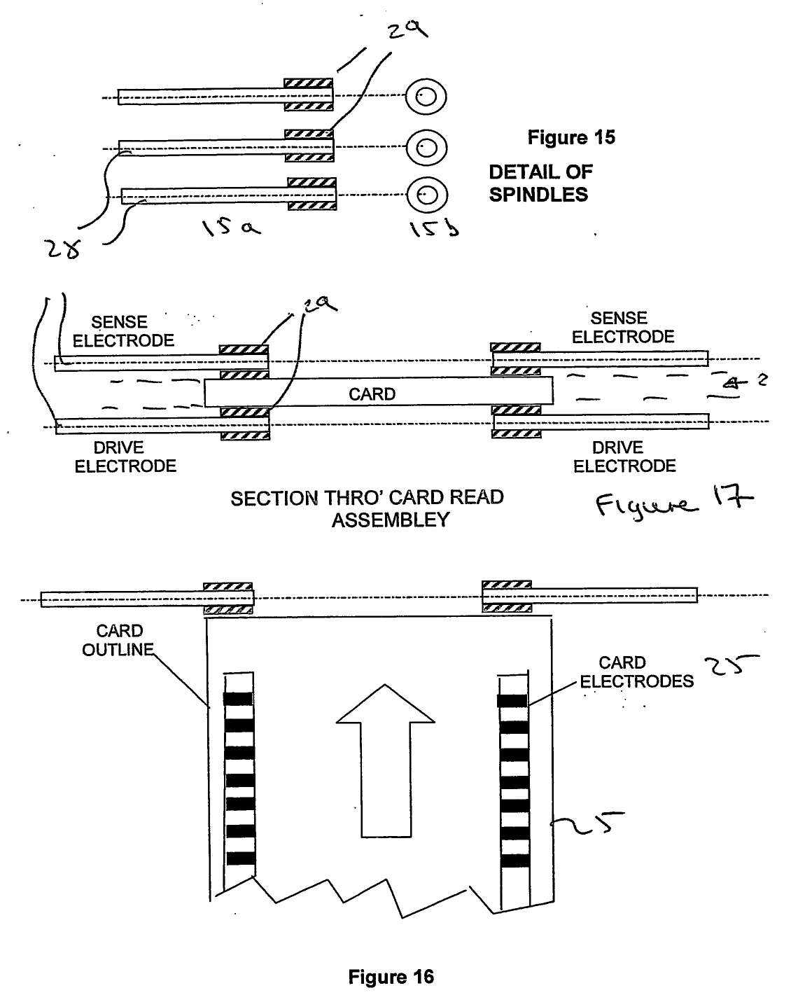

FIG. 15a shows contacts suitable for reading cards such as those of FIGS. 12 or 13;

FIG. 15b is an end view of the contacts of FIG. 15a;

FIG. 16 is a schematic plan view of a card approaching the reading contacts of FIGS. 15a and 15b; and

FIG. 17 is a schematic end view corresponding to the configuration of FIG. 16.

It is well known to use binary code or a succession of ones and zeros to represent alphanumeric characters. FIG. 1 illustrates how, for example, the letter W might be represented as 1010111 in binary code. Binary code is extremely flexible and can therefore be used to represent any message which can be written down as a sequence of alphanumeric characters. As discussed above, bar codes have been extensively used to store information.

One limitation on the use of optical binary or bar codes to store messages has been space. It is necessary to ensure that the code (however it is represented) can be clearly read and adjacent ones or zeros do not merge. Bar-code standards also make use of specified widths and consequently bar codes include large bars and spaces. They are therefore reasonably large and cannot store large amounts of information in small areas or spaces.

EP-A-0-565 738 discloses a two-dimensional bar code which essentially comprises a number of rows of bar codes. The provision of a number of rows clearly increases the amount of information which can be coded. However, the need to provide sufficiently large and distinct bars and spaces to be picked up by a bar code reader means that the amount of information which can be stored on, say, a small surface such as the free space on a credit or payment card remains relatively small.

The preferred embodiment of the present invention stores information in a digital or binary format as an array or matrix of binary ones and zeros or yeses and nos formed by an array or matrix of switches 1 or electrical contacts. This arrangement allows a lot of information to be stored in a small space. The arrangement is also difficult to tamper with and cheap to produce.

FIGS. 2a and 2b illustrate how an embodiment of the invention represents the binary equivalent of the alphabet character W (see FIG. 1). FIG. 2a is a schematic view in which elements below the substrate which would not be visible from the top are shown in dotted outline whereas elements above the substrate which would be visible from the top are shown in the continuous outline. The binary ones or yeses are formed by conductive vias 2 which pass through an insulating substrate 3 which separates two sets 4, 5 of parallel conductors. The binary ones or yeses are therefore points where current or signals can flow from a conductor 4 on one surface of the substrate 3 to a conductor 5 on the other opposite surface of the insulating substrate 3. The binary zeros or nos are formed or represented by the absence of conductive vias. These absences correspond to points where conductors on opposing sides of the substrate cross each other but where there is no means for communication between the conductors on opposite sides of the substrate.

The arrangement of FIGS. 2a and 2b does not require an optical reader to be decoded and the ones and zeros can therefore be placed closely together and lots of information coded into a relatively small area.

By way of example, an embodiment of the invention comprising a security insert or memory storing personal identification information will now be described. The invention is, however, suitable for any ROM (or read only memory). It will readily be appreciated that whilst the following discussion refers to the presence and absence of vias as corresponding, respectively, to binary ones and zeros, it could be the other way round so that the presence and absence of vias corresponding to binary zeros and ones respectively.

The potential user of a document, such as a passport, credit or payment card, which is only intended for authorised use by a particular individual or group of individuals would fill (see FIGS. 3 and 4) in an application form 6 which requests security or personal information about the potential user. The intention is that the requested information be of the type that an unauthorised user of the card would not know. For example, the application form 6 (which may be screen or paper based) may request full date of birth, place of birth, full name, mother's maiden name etc.

The information on the completed application form 6 is then reduced to binary data in the known manner (see FIGS. 1 and 2) to produce a binary matrix or array of ones and zeros.

By representing the ones as a filled square and the zeros as a blank, the complete matrix array of data can be considered to be a single graphics image 7. A single graphics image of a matrix of blanks and filled squares (or black and white pixels) can be represented as a single graphics image file using known systems or formats such as RS274x or Gerber format. Gerber format is a known standard defined by the Electrical Industrial Association of the United States of America under standard EIA-274-D.

The binary matrix of ones and zeros and/or the graphics image file may be scrambled or otherwise encrypted so that an alternative encrypted matrix is represented and the encoded data can only be determined therefrom by someone who is so authorised and possesses the encryption key. A large amount of data may be stored as a compact single graphics image file representing a matrix of binary 1's and 0's. The graphics may be verified or compared to a stored graphics image file which represents, say, an authorised user by carrying out a direct comparison (e.g. a single EXCLUSIVE-OR operation). As a means of keeping the individual's data secure the graphics file only is sent to the production line, the bank and the issuing authority.

The graphics file representing the binary code matrix or array is then used to create a security data insert 8 containing the information of the completed application form. This insert may embody the present invention and be built in the manner described below to then be fixed to documents such as passports, credit or payment cards. It could of course also be affixed to any item which is to be used only by an authorised person or authorised persons such as, for example, a hire car, aircraft or military equipment.

The information represented by the matrix or array of binary 1's and 0's (i.e. of the completed application form) is stored on the security data insert 8 by creating a pattern or relief on the data insert which corresponds to the graphics image 7 and matrix. The graphics image file (which as, discussed above, may be an encrypted version of the image representing the original matrix or array) is used to drive means for modifying the surface of the data insert 8.

Referring to FIGS. 6 to 10 a matrix of possible bit locations (i.e. a bit map) is defined by the cross-over points 9 of a first set of parallel conductors 4 overlaid by a second set of parallel conductors 5 perpendicular to the first set of parallel conductors 1. The two sets of parallel conductors are separated by and supported on an insulating substrate 3. Each of the first set of conductors 4 defines an input bus and each of the second set of conductors defines an output bus 5. The input buses 4 are connectable to a power supply circuit through terminals or contact pads 10 and the output buses 5 in a similar manner are connectable to a circuit containing the logic units for analysing the sensor output.

Each bit corresponding to a binary one or yes includes a conductive via 2 connected with one of the first set of conductors 4 and connected to one of the second set of conductors 5 over which it crosses. Current/information can flow from the input bus conductor 4 of a cross-over point whose conductors are connected through a via to the output bus 5 of that bit location.

A pre-determined selection of the cross-over points 9 include conductive vias 2 connecting the conductors 4, 5 crossing over each other at those points so as to bridge the gap between the two conductors. Current/information can then flow from the input bus 4 to the output bus 5 via the conductive via 2 or hole. Each conductive via may have a surface application of 0.2 microns of Gold metal to achieve a resistance through the Via between the metallized surfaces of 10,000 ohm has an associated resistance resulting in a potential drop across a cross-over point connected through a via.

The conductors 4, 5 forming the input and output buses, are supported by a deformable support or substrate. The deformable substrate may be made from a flexible material such as KALADEX (ICI trade mark for a polyester product), KAPTON, MYLAR, (Du Pont trade marks for polyimide and polyethylene products respectively), METALOYAL (trade mark of Toray Industries for a polyimide product) or UPILEX (UBE trade mark for polystyrene product).

As illustrated in FIG. 2a, and discussed above the binary matrix or array is stored on the security data insert as a matrix or array of electrical switches 1 with the ones each being represented by a closed switch where the conductive vias 2 connect the connectors on opposing faces of the substrate and the zeros each being represented by an open switch where the conductors are not so connected (or vice versa). The locations of the switches of the matrix or array are defined by the cross-over points of two sets of conductors in a manner similar to those described in EP 459 808 and WO 98/11500, whose contents are herein incorporated by reference.

In order to keep the text of the present application to a reasonable length, the contents of these prior publications EP 459 808 and WO 98/11500 are not being entirely repeated herein although they are to be considered part of the disclosure of this application.

The locations of the closed and open switches may be determined in a manner similar to that described in EP 459 808 whose contents are herein incorporated by reference.

A first surface (see FIG. 7) of the substrate 3 includes a pattern of conductive material defining a first set of parallel electrodes or conductors 4 (forming input buses), which are connected by conductive tracks to contact portions 10 for connecting the first set of electrodes to the contacts of a driver circuit (not shown). The second opposite surface (see FIG. 6) of the substrate 3 includes a pattern of conductive material defining a second set of parallel electrodes or conductors 5 perpendicular to the first set. The pattern of conductive material on the second surface also defines conductive tracks and contacts connecting the second set of electrodes (output buses) to the contacts of a sensing circuit (not shown).

Those nodes or cross-over points having an associated via 2 can be considered to essentially be closed switches whereas as those nodes which do not have an associated via can be considered to be open switches. The vias therefore represent ones and nos without vias represent zeros in a binary code matrix formed by the pattern of conductors 4, 5 and vias 2 on the substrate 3.

As described above, each bit includes an insulating substrate separating mutually orthogonal conductors 4, 5. The separated conductors of a binary one are connected by a conductive via 3 which directly passes into and connects with the conductor 5 forming the drive electrode and at its other end connects with the second conductor 6 (forming the sensing electrode) via a contact pad 13 and conductive polymer 14. Suitable conductive polymers may be liquids which when applied to the surface of a substrate polymerise at room temperature to yield a sheet resistance of around 10 Kohm/square.

Current information can flow through the vias 3 from the input bus 4 to the output bus 5 at those bit locations at which the first and second conductors are connected. Each signal via has an associated resistance resulting from the inherent resistance established in the Via in series with the sheet resistance of the polymer across the Contact Gap, i.e. the gap between the Pad and the Sensing Electrode. This results in a potential drop across a cross-over point bridged by a signal via (see FIG. 11). As discussed in EP-A-459 808 this potential drop allows one to determine the cross-over points which are connected by supplying a drive signal or current to each drive electrode in turn and monitoring the outputs from the sensing electrodes.

In the embodiment of the invention described above the bit map and the associated conductors forming the input and output buses are supported by a deformable support or substrate and form a self supporting security insert having the patterns of conductors on two of its surfaces.

In an alternative embodiment, the security insert or memory device may be made up on a silicon support in the matter described in EP 459 808. In such an embodiment, the security insert or memory device may be made by micro photolithographic techniques used in the manufacture of integrated circuitry. Thus upon a relatively indeformable support (which may be silicon), the first conductors are deposited by masking and vacuum deposition or plating and/or plating or vacuum deposition, and thereafter, masking and etching as necessary. A polyimide or similar insulative layer may then be grown or deposited over the first conductors with respective vias being provided to the first conductors at what will become the cross-over or bit points. A second metal layer is similarly deposited on the insulative material layer so as to provide the second conductors. A further polyimide or similar insulative material may then be grown or deposited thereover to protect the second conductors such as a polyimide, polyester, polystyrene, or polyethylene terephthalate coated with a thin layer of, for example a conductive metal such as gold to produce the circuit elements.

The plastics deformable substrate suitable for use in the embodiment of FIGS. 2a to 10 must be capable of withstanding the likely mechanical stresses and environmental conditions to which it is likely to be subjected, as well as have the necessary electrical and machinability properties.

Polyethylene terephthalate or polyimide sheets 10 to 50 μm thick have been found to be highly suitable as substrates as they can be metallised and subsequently machined or etched by established processes, and they are able to meet the necessary performance parameters.

Particularly desirable material properties of deformable substrates for plastics transaction cards including a memory device, or bit map on a debit or credit card are found to be as follows:
a) a high tensile strength with a Youngs Modulus in the range 3000 to 6000 MPa; 5500 MPa is a preferred value;
b) low thermal shrinkage i.e. dimensionally stable throughout the temperature range −10° C. and 250° C. A glass transition temperature greater than 200° C. is preferred;
c) plastics sheet should be flexible, whilst easy to handle without causing wrinkles. A thickness of 25 μm is suitable for KAPTON or MYLAR substrates.
d) Plastics should be easy to machine using conventional machine tools, and preferably also lasers.
e) good resistance to hydrolysis—ideally less than 0.8% in twenty-four hours at 25° C.;
f) good resistance to corrosive agents such as strong acids and alkalis, sodium hydroxide, acetic acid and similar;
g) high sheet resistance (10¹⁶ Ω/□;
h) high contact and bulk resistance (volume resistivity 10¹⁸ Ωcm;
i) relatively high melting point—125 to 250°—preferably 250° C.

In order to maximise the life of the memory devices, the plastics properties should be stable throughout the circuit's intended life.

A security insert as described above may be incorporated in a transaction card (see FIG. 12a and 12b) where it can be interrogated via drive/sensing electrodes to allow the identity of the card user to be verified.

In an alternative and improved embodiment of the invention (see FIG. 13) a memory device of the type described above can combined with a fingerprint sensor.

To produce a security insert or memory device combined with fingerprint sensor, a security insert having patterns of input and output buses and vias is made as described above except that rather than having just a first portion 7 of the data present with an array of holes or vias and associated input and/or output buses corresponding to a bit map to be stored, there is also a second portion 22 of the data insert with an array of holes or vias and associated input and output buses corresponding to the bit map to be stored and an array or matrix (and its associated input and output buses) of sensing cells of the type described in EP 459808 and/or WO 98/11500.

The first portion 7 of the data insert corresponding to the memory device has the construction described above in connection with FIGS. 2a to 10. This bit map is formed by either having (“On” or “1”) or not having (“Off” or “0”) vias at conductor cross-over locations. The second portion of the data insert forms the fingerprint sensor.

A third portion 23 of the data insert includes circuitry for addressing or interrogating the bit map and the fingerprint sensor.

The sensing cells of the fingerprint sensor are defined by the cross-over points of the first and second sets of conductors within its fingerprint or second portion of the security insert.

In order to properly define sensing cells rather than bits of a bit map, the fingerprint sensor portion cross-over points each include a contact pad connected with one of the first set of conductors and a second contact pad connected to one of the second set of conductors.

Current/information flows from the input bus conductor of an activated cell to the output bus of the cell when the two contact pads are electrically connected by a contact bridge brought into contact with the two pads in response to pressure applied to the sensor above the respective sensing cell.

The sensor portion also comprises a resiliently deformable membrane supported above the conductors and having conductive tiles on its lower surface. The resiliently deformable membrane could be trapped under edges of an overlying plastics element defining the card upper surface and having therein an access hole for the sensor portion.

Deformation of the resilient membrane by, say, the ridge of a fingerprint pattern brings one of the conductive tiles into contact with contact pads associated respectively with one of the first conductors and one of the second conductors at the cross-over point of the conductors so as to bridge the gap between the two conductors.

Current information can then flow from the input bus to the output bus via the contact or conductive tile. Each sensing cell has an associated resistance resulting in a potential drop across a cross-over point budged by the conductive tile.

The conductive tiles may be as described in any of GB 2243235, EP 459 808, EP 699 325 or WO 98/11500.

A possible alternative deformable membrane construction providing contact bridges is described in WO 98/11499. The membrane is of a material such as MYLAR or KAPTON (trade marks) and, at a thickness of less than 12 μm (preferably about 3 μm), has the necessary properties of strength and deformability. On its surface confronting the matrix, the membrane has a continuous conductive layer of a doped polyaniline copolymer having a sheet resistivity of 30 kΩ/□. This layer can be coated or sprayed onto the MYLAR or KAPTON sheet before this is attached to the sensor. The conductive layer is not connected to a voltage or potential source other than when it connects to electrodes and current flows through it across the gap between the contact pads.

A method of producing data inserts (i.e. a memory devices) and cards incorporating such memory devices will now be described.

A thin sheet (which may be 36 μm 25 micron and 50 micron sheets are supplied as standard) and also suitable polyimide sheet 15 is covered with a 0.01 μm conductive coating (e.g. (stainless steel or copper). The very thin coating is used as a ‘seeding’ layer or key onto which the subsequent Copper is attached. Nickel Ni-chrome or stainless steel are used to achieve this are and are typically 2-10 Angstroms thick, metallised polyimide sheets are available such as the Du Pont PYRALUX (trade mark) product.

Two ultraviolet lasers 17 (one acting on each surface of the metallised insulator having insulating material thereon) ablate metal from the metallised surfaces of the substrate so as to form an conductive pattern corresponding to the desired pattern of conductors on each surface. The location of the laser beams is controlled by mirrors 18.

An array of 10 μm diameter holes is then made through the sheet by, for example, laser ablation using a laser such as a Triple-Yag laser 20. The laser power and exposure depends on the thickness of the steel coating and polyimide sheet. 100-300 mJ/cm² per pulse (known as Fluence) is applied depending upon Laser wavelength. The holes or vias are made at a density corresponding to the desired density of the bit map. A hole is made for each binary “1” or “on” of the bit map being stored. For a uniform bit map configuration with bits defining the corners of squares, the inter hole pitch is approximately 100 μm for a 100 μm bit and approximately 50 μm for a 50 μm bit.

The substrate then passes into an electroplating station 19. More conductive metal (e.g. gold or copper) is then electroplated (to form a layer 10 to 20 microns thick) onto the exposed metal surfaces of the substrate before the remaining insulating material is washed off in a wash station 24. The additional conductive material is required to achieve sufficient level of conductivity as the initial thin layer of steel or copper is too resistive to properly function as input or output buses on its own.

The clean, drilled and electroplated substrate then passes into a via processing station 21. The walls of the holes are coated with copper so as to form conductive vias. This may be done by using the Shadow Process of Electrochemicals Inc in which a thin layer of chemically conductive carbon is adhered to the exposed polyimide and then electroplated with a thin (say 0.5 μm) copper layer.

In the process described above the pattern of conductors on the surfaces of the substrate are produced or traced by ablating conductive material. In an alternative embodiment, a layer of photoresist material can be coated on the metallised substrate and then exposed to form the conductive pattern which can then be drilled, electroplated etc.

The data insert may also be produced by inkjet printing of the design using electrically conductive ink. This pattern may then be electroplated to produce a substantial metal facsimile of the design.

The security insert comprising a hard bit map a pattern or bitmap of conductive vias forming binary 1's (with the absences of a via forming 0's) is then blanked or cut out from the host sheet and encapsulated between two sheets of opaque polyester pre-formed to an ISO Standard shape which when fused together form a plastic card. The polyester sheets have a slot punched through and aligned with the insert contacts allowing the card to be machine read.

Address connector pads 24 are then attached to both sides of the data insert to allow outer surface contact with drive and sense electronics. Typically the drive and sense electronics are separate from the card and from part of the card reading and identifying verification machinery provided by purpose designed ASICs (Application specific Integrated Circuits) assembled within a PCMCIA Card. The plastic (polyester) elements are punched or blanked from a continuous sheet and contain slots which coincide with the connector pads.

Immediately after data implantation the insert is encapsulated within the four layers of polyester which form the plastic card and the assembly heat fused under pressure. The data on the card is thus hidden and can only be read by electronic means when employing the specific software program. The completed card is then sent onwards to the individual who completed the application form. Any attempt to extract the data insert from the assembled laminations will result in damage or removal of the installed data and in damage of the electronic circuitry rendering the device useless.

A high level of security is maintained because the card applicant is the only person with complete knowledge of the data on the card. In use, the graphics image is downloaded and compared with the recorded image at the individual's bank or card agency. This validates the card. The user is then asked to answer questions about themselves put to them at random from the list of data on the card. Correct, unhesitating answers to those questions validates the user and the transaction is approved. Additionally, the greater the value of the transaction the greater the number of questions required to be answered.

Also, one individual does not need several cards for one identity, thus a single card may be employed for multiple applications. The card may be applied to provide a secure form of identity, a credit or charge card, a driver's licence, a passport, a social security card, a medical card, a voting card for elections, a reusable air ticket, an employment card and an access control card for premises, personal computers, the Internet and telephones.

FIGS. 15 to 17 illustrate a mechanism for addressing the data insert circuitry or memory i.e. a reader.

A card reader includes a slot 26 into or through which a card 27 may be inserted or passed. The slot includes, or its opposing sides, contacts formed by spindles 28 having rotatable contact portions 29. These contact portions are formed of a conductive material and are in contact with drive or sensing circuitry (not shown). They can rotate freely around the spindles 28 so that as a card is pushed past them, they rotate as they contact the address connector pads 25 on the card 27.

In other alternative embodiments of the invention, the memory device may include a matrix or array of sensing cells. The matrix may be constructed by any of the methods described in EP 459 808, GB 2243235, EP 699 325 or WO 98/1150 whose contents are herein included by way of reference.

The bit map of binary 1's and 0's is created or formed by a pattern of conducting platelets supported on a resiliently deformable membrane which is placed over the matrix of sensing cells such that the presence of a conducting platelet or portion over a sensing cell closes, an electrical circuit at that cell and creates a binary 1. Where there is no platelet at a sensing cell, no signal can flow between the conductors at that cell and a binary 0 results.

Once the array of switches is fabricated in the manner described in any of EP 459 808, LB 2243 235, EP 699 325 or WO 98/11500, a pattern of platelets defining the bit may be made by inkjet printing of a conductive pattern.

1. A memory device comprising an array of bits or binary units, the bits being defined by a plurality of first conductors and either a second conductor or a plurality of second conductors overlying and separated from the first conductors, each bit including a cross-over point between one of the first conductors and the second conductor, or one of the second conductors, and wherein the status of each bit or binary unit is determined by the presence or absence of a signal bridge connecting the first and second conductors at respective cross-over point.

2. A memory device according to claim 1 wherein the plurality of first conductors are substantially parallel to each other and substantially orthogonal to the second conductor or conductors, and the plurality of second conductors are substantially parallel to each other.

3. A device according to claim 1 wherein the signal bridge is a capacitor.

4. A device according to claim 1 wherein the signal bridge is a contact bridge.

5. A memory device according to claim 1 comprising an insulating layer between the first and second conductors, the insulating layer including a signal via at each of the cross-over points through which said signal bridges connect the respective first and second conductors.

6. A memory device according to claim 1 comprising a bit map or bit pattern layer having a pattern of conductive elements forming contact bridges on a surface overlying the array of cross-over points for connecting each of those cross-over points through which a said contact bridge connects the respective first and second conductors at the respective cross-over point.

7. A memory device according to claim 6 wherein there are switch means on a surface of the array of bits or cross-over points and associated with each bit or cross-over point, each switch means including a first contact portion of one of the first conductors and a second contact portion of the second conductor or one of the second conductors wherein the first and second contact portions of each bit or cross-over point are separated from one another, and the contact portions of predetermined selection of the bits or cross-over points are connected by the contact bridges of the overlying bitmap or bit pattern layer to connect the first and second conductors at each pre-determined selected cross-over point.

8. A memory device according to claim 5 wherein the insulating layer is a thin sheet of a plastics material such as a polyimide, polyester, polystyrene or polyethylene.

9. An identifying or transaction card, for example, a credit card, debit card, identity card, driving license, passport, or social security card including a memory device according to claim 1 programmed with identification data or information characteristic or personal to the authorized user or users of the card.

10. A card according to claim 9 further comprising a fingerprint sensor.

11. A card according to claim 10 comprising a matrix of cells, each cell being defined by a cross-over point between one of a plurality of parallel first conductors and one of a plurality of parallel second conductors overlying and separated from the first conductors, wherein a first portion of the matrix is the memory device and a second portion of the matrix is a fingerprint sensor, wherein the cells of the first memory device portion are the bits of the memory device, and the cells of the second fingerprint sensor portions are the sensing cells of a fingerprint sensor, the card also including a resiliently deformable membrane overlying the second fingerprint sensor portion of the matrix, the membrane having conductive portions on its underside to connect the first and second conductors of one or more sensing cells in response to the presence or absence of a fingerprint ridge pressing down on the deformable membrane.

12. A card according to claim 11 wherein the second memory device portion includes a first memory section for storing a selected fingerprint pattern, and a second memory section for storing information about a selected authorized user or selected authorized users of the card.

13. A card according to claim 12 wherein the first memory section is adjacent and contiguous to the fingerprint sensor portion, and the second memory section is adjacent and contiguous to the first memory section and the fingerprint sensor portion.

14. A card according to claim 11 wherein the card includes a set of drive electrodes connected to the first (or second) conductors for supplying signals thereto and a set of sensing electrodes connected to the second (or first) conductors for monitoring the output therefrom.

15. A card according to claim 14 wherein a single set of drive electrodes and a single set of sensing electrodes may be used to address or interrogate both the memory device and the fingerprint sensor.

16. A method of making a memory device comprising an array of bits, the method comprising the steps of:
providing an insulating support;
forming a plurality of first conductive portions on a first surface of the support;
forming a second conductive portion or a plurality of second conductive portions on a second surface of the support, separated from and crossing the first conductive portions at cross-over locations; and
corresponding to the locations of the signal vias providing signal vias extending through the insulating support at selected cross-over locations;
wherein to establish an electrical coupling is established between respective first and second conductive portions at the selected cross-over locations through the signal vias;
wherein the status of each bit is determined by the presence or absence of a signal via at the respective cross-over location.

17. A method according to claim 16 wherein the signal vias are provided by drilling holes extending through or partly through the insulating support and the walls of the holes are coated with a conductive material.
